(19) United States
(12) Patent Application Publication
(10) Pub. No.: US 2014/0052438 A1
(43) Pub. Date: Feb. 20, 2014

(54) MANAGING AUDIO CAPTURE FOR AUDIO APPLICATIONS

(71) Applicants: Frank Yerrace, Woodinville, WA (US); Kishore Kotteri, Bothell, WA (US); Ryan Beberwyck, Redmond, WA (US); Gerrit Swaneveld, Bellevue, WA (US); John Bregar, Bainbridge Island, WA (US); Rian Chung, Redmond, WA (US)

(72) Inventors: Frank Yerrace, Woodinville, WA (US); Kishore Kotteri, Bothell, WA (US); Ryan Beberwyck, Redmond, WA (US); Gerrit Swaneveld, Bellevue, WA (US); John Bregar, Bainbridge Island, WA (US); Rian Chung, Redmond, WA (US)

(73) Assignee: Microsoft Corporation, Redmond, WA (US)

(21) Appl. No.: 13/590,060

(22) Filed: Aug. 20, 2012

(51) Int. Cl. G06F 17/00; G10L 21/00

(52) U.S. Cl. 704/201; 700/94; 704/E21.001

(57) ABSTRACT

In a computer system that permits multiple audio capture applications to get an audio capture feed concurrently, an audio manager manages audio capture and/or audio playback in reaction to trigger events. For example, a trigger event indicates an application has started, stopped or otherwise changed a communication stream, or indicates an application has gained, lost or otherwise changed focus or visibility in a user interface, or indicates a user change. In response to a trigger event, the audio manager applies a set of rules to determine which audio capture application is allowed to get an audio capture feed. Based on the decisions, the audio manager manages the audio capture feed for the applications. The audio manager also sends a notification to each of the audio capture applications that has registered for notifications, so as to indicate whether the application is allowed to get the audio capture feed.

### BACKGROUND

Many modern computer systems support voice communication through voice telephony software, a voice chat feature of a game, or another type of voice communication application. For example, voice over Internet Protocol (“VoIP”) software can be provided for desktop computers, but also for tablet computers, smartphones and computer systems having other form factors. In addition to voice communication applications, other types of applications may provide audio recording, speech-to-text conversion or otherwise use an audio capture feed. In some cases, a computer system allows a user to run multiple audio capture applications concurrently. One or more of the audio capture applications may be running in the background, with little or no indication that they are running. Or, a computer system may allow a user to sign in and run a voice communication application or other audio capture application without terminating an audio capture application started by a previous user.

In either case, there is a risk of inadvertent disclosure from the perspective of the user if the voice input captured from a microphone is unexpectedly fed to both audio capture applications. In the first case (multiple audio capture applications running concurrently), the user may think that only one of the audio capture applications is running, under the incorrect assumption that the call for the other application has been terminated or put on hold. In the second case (audio capture application of previous user still running), the current user might not even be aware that the additional audio capture application was ever running. More generally, when a computer system permits multiple audio capture applications to be open and getting an audio capture feed concurrently, there is a risk of inadvertent disclosure where someone on a call/audio capture application could potentially listen in on another call/audio capture application.

One approach to addressing this risk is to have each audio capture application prominently indicate whether a call/audio capture is active, whether the microphone is muted or not muted, and so on. How the application visually indicates call status or microphone status is typically left to the application. Depending on how the application manages its display functions and how many applications are running, this approach can provide suitable warning to the user, but there are disadvantages to this approach. A user who is unfamiliar with the application may not correctly interpret the status indication. Or, the status indication may be hidden, obscured or lost in the user interface of the computer system (e.g., if the audio capture application is running in the background, or if the display is crowded with other information).

### SUMMARY

In summary, innovations are described for managing audio capture and/or audio playback for audio capture applications. For example, an audio manager determines which audio capture applications should get an audio capture feed and provide audio output, and mutes/unmutes the audio capture applications as appropriate. In this way, the audio manager can address the risk that an audio capture application in the background may inadvertently record a user's conversation, so that a user will not be surprised by unexpected microphone capture.

According to one aspect of the innovations, in a computer system that permits multiple audio capture applications to get an audio capture feed concurrently, an audio manager manages audio capture. For example, the audio capture applications are voice communication applications, and the audio manager manages microphone input. The audio manager can be implemented as part of an operating system of the computer system, or the audio manager can be implemented in some other way (e.g., as a stand-alone application).

In response to a trigger event, the audio manager applies a set of rules to determine which of one or more audio capture applications is allowed to get an audio capture feed. For example, the trigger event indicates an audio capture application has started, stopped or otherwise changed an audio stream that can use the audio capture feed (e.g., communication stream), or indicates an application has gained, lost or otherwise changed focus or visibility in a user interface (“UI”), or indicates a user change event. The set of rules can be based at least in part on which of the audio capture application(s): (a) is in foreground of the UI, (b) is in background of the UI, and/or (c) was most recently visible. The set of rules can also account for (d) which user is currently signed in and actively using the computer system. The set of rules for audio management can be implemented as decision logic that includes, for a given audio capture application or each of multiple audio capture applications, determining if the application is visible in the UI and, if so, allowing the application to get the audio capture feed; but, if no audio capture application is visible in the UI, allowing the most recently visible audio capture application to retain the audio capture feed.

Based on these decisions, the audio manager manages the audio capture feed for the audio capture application(s). The audio manager can also send a notification to each of the audio capture application(s) that is registered for such notifications to indicate whether the audio capture application is allowed to get the audio capture feed. When an audio capture application provides audio output, the audio manager can also manage audio playback for each of the audio capture application(s).

According to another aspect of the innovations, an audio management architecture includes a registration interface, an event monitor and an audio manager. The registration interface is adapted to register audio capture applications with the audio manager. The event monitor is adapted to monitor the computer system for types of trigger events for management of audio. For example, the event monitor is adapted to monitor (a) whether an audio stream that can use the audio capture feed (e.g., a communication stream) starts or stops, (b) whether there is any change in UI focus or UI visibility for an application, and/or (c) whether a user changes. The audio manager is adapted to, in response to one of the trigger events, apply a set of rules to determine which of the audio capture applications is allowed to get an audio capture feed. The audio manager is also adapted to manage the audio capture feed for the audio capture applications, and can send notifications to those of the audio capture applications that are registered through the registration interface. In addition, the audio manager can be further adapted to manage audio playback for those of the audio capture applications that also provide audio output.

The foregoing and other objects, features, and advantages of the invention will become more apparent from the following detailed description, which proceeds with reference to the accompanying figures.

### BRIEF DESCRIPTION OF THE DRAWINGS

FIG. 1 a block diagram of an example computer system in which some described innovations may be implemented.

FIG. 2 is a diagram illustrating an example scenario in which an audio capture manager and playback manager manage audio for multiple applications.

FIG. 3 is a diagram of an example architecture for managing audio for audio applications.

FIGS. 4a and 4b are flowcharts illustrating example approaches to managing audio capture for audio capture applications.

FIG. 5 is a flowchart illustrating a generalized technique for managing audio capture for audio capture applications.

### DETAILED DESCRIPTION

Innovations are described for managing audio capture and/or audio playback for voice communication applications and other audio capture applications. An audio manager manages the audio capture feed that is used by audio capture applications. The audio manager determines which of the audio capture applications should get the audio capture feed, and mutes/unmutes the audio applications as appropriate. The audio manager can also manage audio playback for the audio capture applications. In common use scenarios, the audio manager addresses the risk of a voice communication application or other audio capture application inadvertently recording a user's conversation or otherwise using an audio capture feed, so that a user will not be surprised by unexpected microphone capture.

The various aspects of the innovations described herein include the following.
Ways to monitor when a user switches to an audio capture application to make it visible in the user interface (“UI”), or switches away from the audio capture application to another application.
Ways to monitor when a different user signs into a computer system without terminating a previous user's applications (including a voice communication application or other audio capture application).
Ways to monitor when a voice communication application or other audio capture application loses the focus of a UI.
Ways to adjust how an audio capture feed is made available to audio capture applications in response to such monitored events and/or other information gathered by monitoring audio capture applications.
Ways to integrate management of an audio capture feed with management of audio playback for voice communication applications and other audio capture applications.
Ways to register a voice communication application or other audio capture application for management of the use of an audio capture feed by the application.
Ways to signal to a voice communication application or other audio capture application that its audio capture feed is being preempted or resumed, which gives the application a chance to provide an appropriate application-specific response and control the end user experience.

The various aspects of the innovations described herein can be used in combination or separately. One or more features of managing audio capture can be used in combination with features of managing audio playback. For example, an operating system can manage audio capture and audio output of voice communication applications and other audio capture applications by determining if and when to mute microphone and speaker streams, so that conversations are not recorded or otherwise used unexpectedly. Or, the features of managing audio capture can be used apart from management of audio playback.

### Example Computer Systems

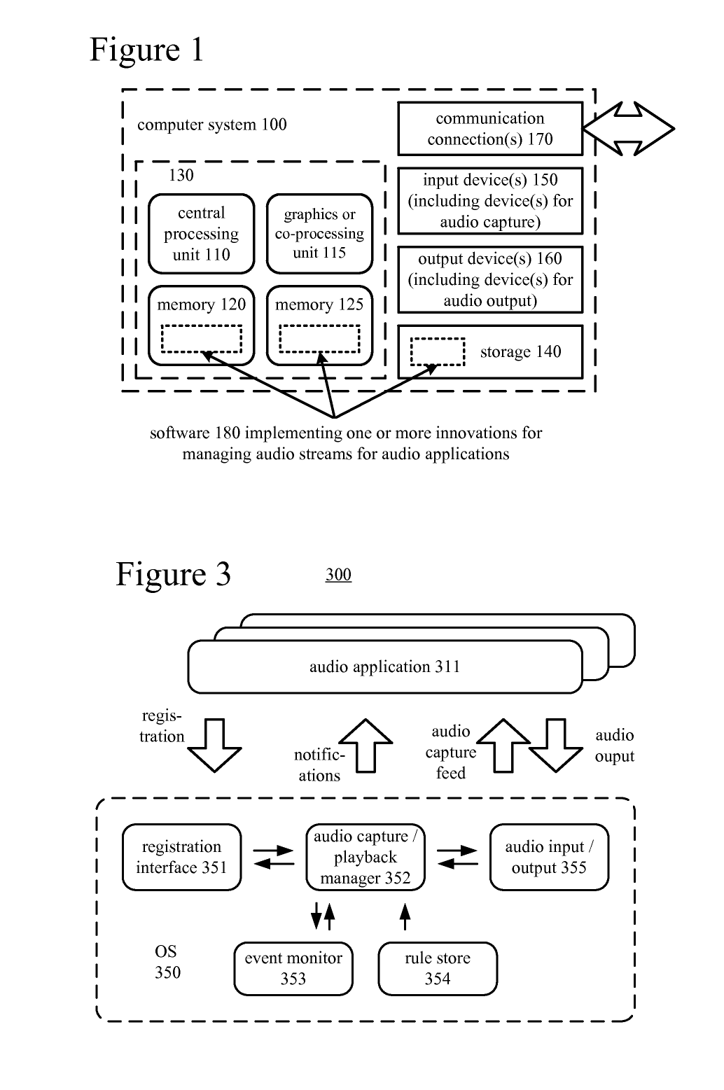

FIG. 1 illustrates a generalized example of a suitable computer system (100) in which several of the described innovations may be implemented. The computer system (100) is not intended to suggest any limitation as to scope of use or functionality, as the innovations may be implemented in diverse general-purpose or special-purpose computer systems. Thus, the computer system can be any of a variety of types of computer system (e.g., desktop computer, laptop computer, tablet or slate computer, smartphone, gaming console, etc.).

With reference to FIG. 1, the computer system (100) includes one or more processing units (110, 115) and memory (120, 125). In FIG. 1, this most basic configuration (130) is included within a dashed line. The processing units (110, 115) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 1 shows a central processing unit (110) as well as a graphics processing unit or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for managing audio capture for audio applications, in the form of computer-executable instructions suitable for execution by the processing unit(s).

A computer system may have additional features. For example, the computer system (100) includes storage (140), one or more input devices (150), one or more output devices (160), and one or more communication connections (170). An interconnection mechanism (not shown) such as a bus, controller, or network interconnects the components of the computer system (100). Typically, operating system software (not shown) provides an operating environment for other software executing in the computer system (100), and coordinates activities of the components of the computer system (100). In particular, the other software includes one or more audio capture applications. The audio capture application(s) can include one or more voice communication applications such as a standalone voice telephony application (VoIP or otherwise), a voice telephony tool in a communication suite, or a voice chat feature integrated into a social network site or multi-player game. The audio capture application(s) can also include an audio recording application, a speech-to-text application, or other audio processing software that can use an audio capture feed. So, depending on the audio capture application, the audio capture feed may be directly recorded or otherwise stored in a persistent way at the system (100), or transmitted/conveyed from the system (100), or converted to some other form such as compressed audio or text that is stored, transmitted, etc. or otherwise used by the application. Typically, a voice communication application uses voice over IP, but alternatively the voice communication application can use any other mechanism for delivery of audio. In addition to audio capture applications, the other software can include common applications (e.g., email applications, calendars, contact managers, games, word processors and other productivity software, Web browsers, messaging applications).

The tangible storage (140) may be removable or non-removable, and includes magnetic disks, magnetic tapes or cassettes, CD-ROMs, DVDs, or any other medium which can be used to store information in a non-transitory way and which can be accessed within the computer system (100). The storage (140) stores instructions for the software (180) implementing one or more innovations for managing audio capture for audio applications.

The input device(s) (150) include one or more audio input devices (e.g., a microphone adapted to capture audio or similar device that accepts audio input in analog or digital form). The input device(s) (150) may also include a touch input device such as a keyboard, mouse, pen, or trackball, a touchscreen, a scanning device, or another device that provides input to the computer system (100). The input device(s) (150) may further include a CD-ROM or CD-RW that reads audio samples into the computer system (100). The output device(s) (160) typically include one or more audio output devices (e.g., one or more speakers). The output device(s) (160) may also include a display, touchscreen, printer, CD-writer, or another device that provides output from the computer system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computer system (100), computer-readable media include memory (120, 125), storage (140), and combinations of any of the above.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computer device. In general, a computer system or device can be local or distributed, and can include any combination of special-purpose hardware and/or general-purpose hardware with software implementing the functionality described herein.

The disclosed methods can also be implemented using specialized computer hardware configured to perform any of the disclosed methods. For example, the disclosed methods can be implemented by an integrated circuit (e.g., an ASIC such as an ASIC digital signal process unit (“DSP”), a graphics processing unit (“GPU”), or a programmable logic device (“PLD”) such as a field programmable gate array (“FPGA”)) specially designed or configured to implement any of the disclosed methods.

For the sake of presentation, the detailed description uses terms like “determine” and “apply” to describe computer operations in a computer system. These terms are high-level abstractions for operations performed by a computer, and should not be confused with acts performed by a human being. The actual computer operations corresponding to these terms vary depending on implementation.

### Example Software Architectures for Managing Audio

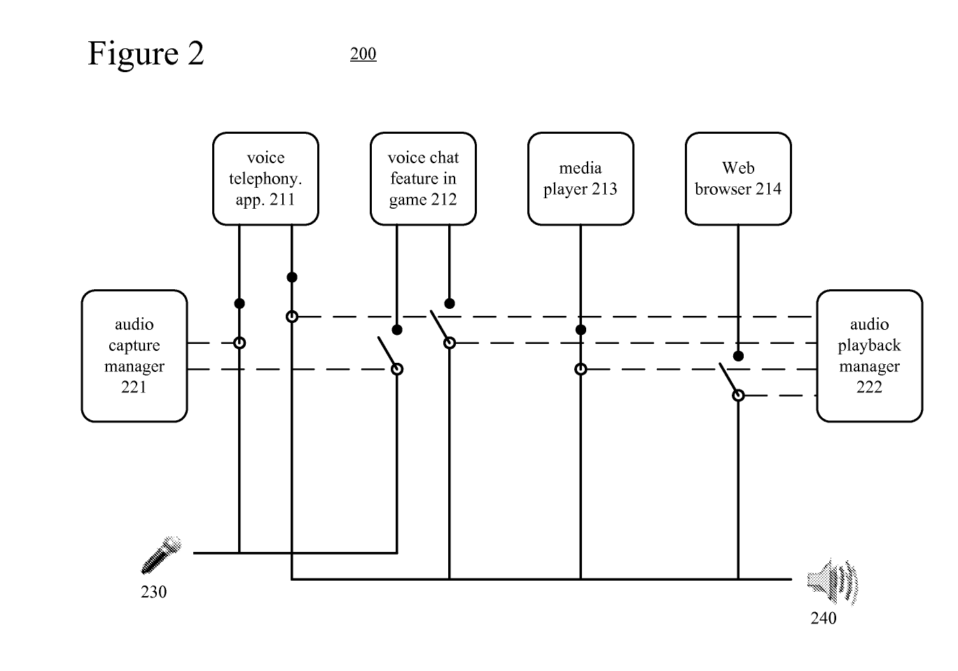

FIG. 2 illustrates an example scenario (200) in which an audio capture manager (221) and audio playback manager (222) manage audio for multiple applications. The audio capture manager (221) and audio playback manager (222) control which applications get an audio capture feed and which applications provide audio output. FIG. 2 shows a high-level representation of these operations. The details of how audio capture and audio playback streams are controlled depend on implementation.

In FIG. 2, the applications include a voice telephony application (211), a voice chat feature of a game (212), a media player (213) and a Web browser (214). The voice telephony application (211) and voice chat feature (212) can get an audio capture feed from a microphone (230). Each of the applications (211-214) can provide an audio output stream to one or more speakers (240). Other scenarios can have more or fewer applications and/or have different applications.

The audio capture manager (221) applies a set of rules to determine which of the audio capture applications (in FIG. 2, the voice telephony application (211) and voice chat feature (212)) are allowed to get the audio capture feed from the microphone (230). The rules can be implemented as decision logic in the audio capture manager (221) or be implemented in some other way. Example rules are explained below. The audio capture manager (221) can notify each of the audio capture applications (211, 212) whether its audio capture is muted using notifications, where the applications (211, 212) have registered to receive such notifications. In any case, the audio capture manager (221) regulates distribution of the audio capture feed. Alternatively, the audio capture manager (221) can manage the audio capture feed in some other way. In FIG. 2, the audio capture manager (221) allows the voice telephony application (211) to get the audio capture feed, but the microphone (230) is muted for the voice chat feature (212).

The audio playback manager (222) applies a set of rules to determine which of the applications (211-214) provides audio for output by the speaker(s) (240). The rules can be implemented as decision logic in the audio playback manager (222) or be implemented in some other way. The audio playback manager (222) can notify each of the applications (211-214) whether its audio output is muted using notifications, where the applications (211-214) have registered to receive such notifications. In any case, the audio playback manager (222) regulates distribution of the audio output. Alternatively, the audio playback manager (222) can manage the audio output in some other way. In FIG. 2, the audio playback manager (222) allows the voice telephony application (211) and media player (213) to provide audio output (e.g., for a call and background music), but audio output is muted for the voice chat feature (212) and Web browser (214).

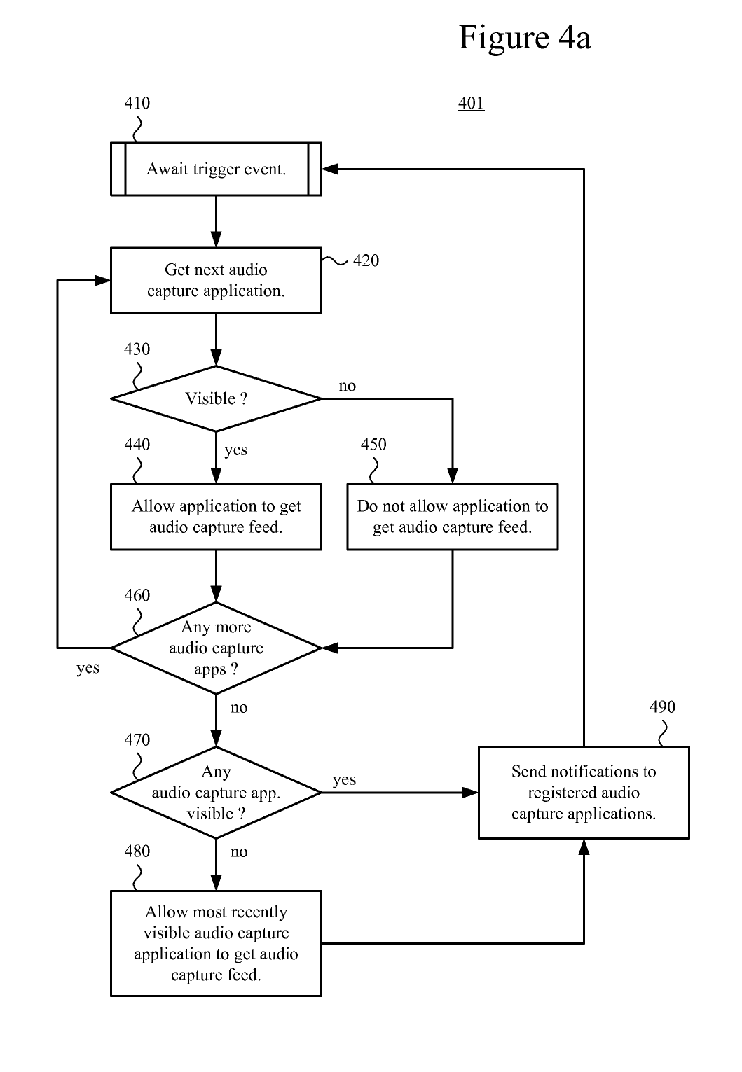

FIG. 3 illustrates an example software architecture (300) for managing audio capture and playback for audio applications. A computer system (e.g., desktop computer, laptop computer, netbook, tablet computer, smartphone) can execute software organized according to the architecture (300) to manage audio for one or more audio applications.

The architecture (300) includes an operating system (350) and one or more audio applications (311). For audio capture management, at least one of the audio application(s) (311) is an audio capture application. For example, an audio application (311) can be a voice communication application such as a standalone voice telephony application (VoIP or otherwise), a voice telephony tool in a communication suite, or a voice chat feature integrated into a social network site or multi-player game. Or, an audio application (311) can be an audio recording application, a speech-to-text application, or other audio processing software that can get an audio capture feed. Or, an audio application can be a playback only application such as a media player. Overall, an audio application (311) can register with the audio capture/playback manager (352) of the operating system (350), then receive notifications from the audio capture/playback manager (352) about management of the audio capture feed and/or audio output for the application (311). Based on the notifications, the audio application (311) can control the user experience in a way that is consistent with the notifications but left to the application (311). For example, if a voice communication application receives notifications that its audio capture feed and audio output are muted, the application can decide whether to put a call on hold or terminate the call.

The operating system (350) includes components for rendering (e.g., rendering visual output to a display, generating audio output for a speaker), components for networking, components for processing audio capture from a microphone, and components for managing applications. More generally, the operating system (350) manages user input functions, output functions, storage access functions, network communication functions, and other functions for the computer system. The operating system (350) provides access to such functions to an audio application (311). The operating system (350) can be a general-purpose operating system for consumer or professional use, or it can be a special-purpose operating system adapted for a particular form factor of computer system. In FIG. 3, the audio input/output (355) represents audio capture processing and audio output processing. The audio input/output (355) conveys audio data to/from the audio application(s) (311) through one or more data paths, as controlled by the audio capture/playback manager (352) through one or more control paths.

The registration interface (351) provides a way for a voice communication application or other type of audio application (311) to register for notifications from the audio capture/playback manager (352). For example, through the registration interface (351), a voice communication application declares that it uses an audio stream for input and output. Or, a media player declares that it uses an audio stream for audio output. The voice communication application or other audio application (311) can also provide other types of information, e.g., category of audio stream. Different stream categories can be associated with different behaviors. For example, a foreground only media stream is used for a game or film that is paused when it goes to the background. Or, a background capable media stream is used for music playback that is expected to continue even if a media player or other software associated with the stream is in the background of the UI. A communication stream is used for voice telephony or real-time chat for a voice communication application. Multiple categories can be assigned to a single application. For additional details about audio stream categories for playback in example implementations, see the white paper entitled, “Audio Playback in a Metro Style App.” For audio capture, the category of communication stream indicates a stream that is used for voice telephony, real-time chat, or other voice communication. Alternatively, the architecture (300) accounts for other and/or additional categories for audio streams (e.g., other categories that can use the audio capture feed).

Through the registration interface (351), a voice communication application or other audio application registers to receive various types of notifications from the audio capture/playback manager (352). For example, an audio application (311) can register to receive notifications about the audio capture feed. For the audio capture feed, a notification provides the application (311) with information on its capture state such as whether the microphone input is muted or unmuted for the application. A voice communication application or other audio application (311) can also register to receive notifications about its audio playback state, such as whether the application is to be heard at its full volume level, an attenuated (or “ducked”) level, or muted altogether. For additional detail about sound level notifications for audio playback in example implementations, see the white paper entitled, “Audio Playback in a Metro Style App.” Alternatively, the architecture (300) accounts for other and/or additional types of notifications for management of audio. Typically, notifications are provided to a registered application in response to a trigger event that causes a change in audio capture state and/or audio playback state for one or more of the audio applications (311). An application (311) can also query the audio capture/playback manager (352) for information about its audio capture state or audio playback state.

A user can generate user input that affects audio management for voice communication applications and other audio applications. The user input can be tactile input such as touchscreen input, mouse input, button presses or key presses or voice input. For example, a user may initiate or answer a new call in a voice communication application, or terminate a call. Or, the user may move an audio application (311) from the foreground of the UI to the background, or vice versa, or otherwise change the visibility of the application (311). Or, the user may change which application currently has the focus in the UI. Changes in the status of an audio application (311), resources used by the application (311) or the status of the system are represented with events.

The event monitor (353) monitors the computer system for types of trigger events, listening for certain types of events that will trigger a response by the audio capture/playback manager (352). The trigger events can be application-level messages about the status of an application or resources used by the application, system-level messages about which user is signed in, or other messages. Which types of events qualify as trigger events depends on implementation. In example implementations, the event monitor (353) monitors whether any of the audio applications starts or stops an audio stream that can use the audio capture feed (e.g., a communication stream), changes (gain or loss) of UI focus or UI visibility for any of the applications, and user change events.

The audio capture/playback manager (352) reacts to trigger events from the event monitor (353) by managing audio capture and audio playback for voice communication applications and other audio applications (311). For audio playback, the manager (352) controls which audio streams can be heard/not heard for the audio application(s) (311). In general, for audio capture, the audio capture/playback manager (352) applies a set of rules to determine which of the audio applications is allowed to get an audio capture feed, and manages the audio capture feed accordingly for the audio applications. In example implementations, the audio capture/playback manager (352) follows rules as described below to manage audio capture and audio playback. The white paper entitled, “Audio Playback in a Metro Style App” describes alternative rules the audio capture/playback manager (352) can follow to manage audio playback. The rules can be implemented as decision logic for the audio capture/playback manager (352) to follow, considering status of audio applications (311). Or, the rules can be implemented in some other way such as a rules engine that applies the rules against the audio applications. Based upon the decisions made when applying the rules, the audio capture/playback manager (352) sends notifications to those of the audio application(s) (311) that have registered through the interface (351). For example, the audio capture/playback manager (352) sends a notification to a voice communication application to indicate whether the application (a) is muted and has lost the audio feed, or (b) is unmuted and has gained the audio feed. For audio playback, the audio capture/playback manager (352) can send a notification to an audio application (311) to indicate whether the sound level for the application (311) is full, low or muted.

The rule store (354) stores rules used by the audio capture/playback manager (352). As needed, the rule store (354) gets rules from local file storage or from network resources. Or, the rules can be hardcoded or hardwired into the audio capture/playback manager (352) itself. In some implementations, a user can change how the audio capture/playback manager (352) manages audio for all audio applications or a specifically identified audio application. Such changes to the rules by a user are reflected in the rules stored in the rule store (354) or elsewhere.

Alternatively, the operating system (350) includes more or fewer modules. A given module can be split into multiple modules, or different modules can be combined into a single module. For example, the audio capture/playback manager (352) can be split into multiple modules that control different aspects of audio management, or the audio capture/playback manager (352) can be combined with another module (e.g., the rules store (354) or registration interface (351)). Functionality described with reference to one module can in some cases be implemented as part of another module. Or, instead of being part of an operating system, the audio manager can be a standalone application, plugin or type of other software.

### Example Rules for Managing Audio for Audio Capture Applications

An audio manager applies rules to determine how to manage an audio capture feed and/or audio output for one or more audio capture applications. The rules can account for the number of calls that are active, which audio capture applications are in the foreground of the UI, which audio capture applications are in the background of the UI, which audio capture application was most recently used (e.g., visible) and/or other factors.

In example implementations, the audio manager applies the following rules to manage audio capture and audio playback for one or more audio capture applications in a computer system with a UI. Graphically, the foreground of the UI includes a main part for display as well as a docking bar. Applications rendered in the main part or docking bar are visible, but applications in the background are not visible. The rules help manage audio streams so that the user either sees a visual indication of each active, unmuted audio capture application that has the audio capture feed, or the user can be assured that only one such audio capture application is active and unmuted.

Single Communication Stream Open.

When a single communication stream (or other audio stream that uses an audio capture feed) is open, the audio capture application for that stream has priority and is not muted. Thus, if there is one voice communication application in a call, that voice communication application has the communication focus (gets the audio capture feed) whether the application is in the foreground or background. When another stream that can use the audio capture feed is opened, the audio manager will determine which stream(s) should have priority and will mute the other stream(s), as appropriate.

Audio Capture Application(s) in Foreground.

An audio capture application in the foreground of the UI is allowed to get the audio capture feed and provide audio for playback. The application in the foreground can be in the main part of the display or in a docking bar, but is visible in either case. When there are multiple audio capture applications in the foreground, each of the audio capture applications in the foreground is allowed to get the audio capture feed and provide audio for playback. More generally, if a user sees an audio capture application in the UI, the audio capture application is allowed to get the audio capture feed.

Audio Capture Applications in Foreground and Background.

When there are one or more audio capture applications in the foreground and one or more audio capture applications in the background, each audio capture application in the foreground of the UI is allowed to get the audio capture feed and provide audio for playback. None of the audio capture applications in the background gets the audio capture feed or provides audio for playback. For example, when a call is active for a first voice communication application in the foreground, and another call is initiated or answered for a second voice communication application, the audio manager facilitates a switchover to the second application. The first application is switched to the background and muted.

Audio Capture Applications in Background.

When there are multiple audio capture applications in the background, and there is no audio capture application in the foreground, only the most recently used audio capture application (in the background) is allowed to get the audio capture feed and provide audio for playback. For example, the most recently used audio capture application is the one that was most recently visible in the UI. Thus, if no audio capture application is visible, the most recently used audio capture application is allowed to get (or, more specifically, retain) the audio capture feed and provide audio for playback.

Switch from Background to Foreground.

If an audio capture application in the background is brought to the foreground, that audio capture application regains voice capture and playback ability (if it did not already have it as the most recently used application).

User Change.

When a new user signs in to a computer system, all audio capture applications for the previous user are muted and do not get the audio capture feed. That is, any active communication streams for the previous user are muted. Voice communication applications for the previous user may be unmuted if and when the user logs back in to the computer system.

In the example implementations, these rules are evaluated whenever any audio capture application starts or stops a stream that can use the audio capture feed (e.g., communication stream), whenever any audio capture application gains or loses focus (or visibility) in the UI, and whenever a user logs off or switches. Upon any trigger event, all of the audio capture applications are evaluated.

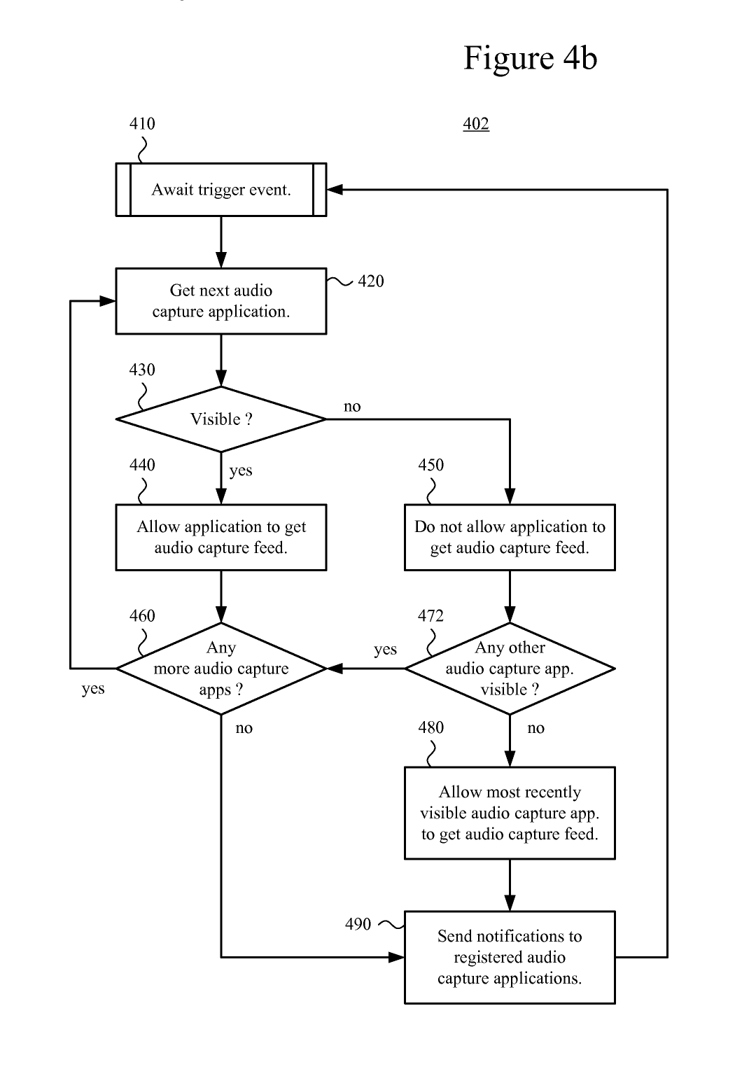

FIGS. 4a and 4b show decision logic that incorporates the foregoing rules for audio capture management. An audio manager can follow the approach (401) in FIG. 4a, approach (402) in FIG. 4b, or some other approach to implementing the foregoing rules.

With reference to FIG. 4a, the audio manager awaits (410) a trigger event such as one of the trigger events described above. In response to the trigger event, the audio manager gets (420) a next audio capture application and determines (430) whether the audio capture application is visible. If the application is visible (e.g., in a main part of the UI, in a docking bar of the UI), the audio manager allows (440) the application to get the audio capture feed. If the application is not visible (e.g., in the background of the UI), the audio manager does not allow (450) the application to get the audio capture feed.

The audio manager then determines (460) whether there are any more audio capture applications to be evaluated. If so, the audio manager continues by getting (420) the next audio capture application. In this way, the audio manager can evaluate whether each of the audio capture applications is visible or not visible, and manage the audio capture feed accordingly.

If there are no more audio capture applications to be evaluated, the audio manager checks if all audio capture applications are in the background. The audio manager determines (470) whether any of the audio capture applications is visible. If not (that is, all audio capture applications are in the background), the audio manager allows (480) the most recently used audio capture application (e.g., most recently visible audio capture application) to get the audio capture feed. The audio manager then sends (490) notifications to those of the audio capture applications that are registered for notifications, so as to indicate status for the audio capture feed.

FIG. 4b shows an alternative approach with different timing. As in the approach of FIG. 4a, the audio manager awaits (410) a trigger event and, in response to the trigger event, gets (420) a next audio capture application and determines (430) whether the audio capture application is visible. If the application is visible, the audio manager allows (440) the application to get the audio capture feed and determines (460) whether there are any more audio capture applications to be evaluated. If so, the audio manager continues by getting (420) the next audio capture application.

If the application is not visible (e.g., in the background of the UI), the audio manager does not allow (450) the application to get the audio capture feed. The audio manager then determines (472) whether any other audio capture application is visible. If not (in other words, if all audio capture applications are in the background), the audio manager can terminate the evaluation of audio capture applications more quickly when no audio capture application is visible. In this case, the audio manager allows (480) the most recently used (e.g., visible) audio capture application to get the audio capture feed.

After all audio capture applications have been evaluated, or after the audio manager determines that no audio capture application is visible, the audio manager sends (490) notifications to registered voice communication applications, respectively, to indicate status for the audio capture feed.

Alternatively, the audio manager applies other and/or additional rules. For example, the audio manager applies different rules for a UI has a different organization. Or, an audio capture application in the background is allowed to get an audio capture feed in some cases even if the audio capture application was not most recently visible. As another example, the audio manager can apply one or more rules to distinguish between voice communication applications and other audio capture applications. For example, the audio manager monitors the UI state of all applications. The audio manager also tracks which audio capture applications are voice communication applications and which audio capture applications are not voice communication applications. This can allow the audio manager to prevent the audio capture feed from going to a non-communication audio capture application that is not visible (e.g., that is in the background).

### Use Scenarios for Managing Audio Capture

This section explains several scenarios in which the foregoing rules from example implementations are applied. In the scenarios, the UI includes a foreground with a main part and docking bar, as well as a background. The communication focus indicates which of the audio capture applications gets the audio capture feed.

Table 1 shows audio management for a first example scenario. Initially, a first voice communication application (“VCA1”) is in the main part of the UI and supporting a call. A Web browser and second voice communication application (“VCA2”) are in the background. When the user answers a call in VCA2, VCA2 is switched to the main part of the UI, and VCA1 is switched to the background. The audio manager reacts to the changes in UI visibility/focus by allowing VCA2 to get the audio capture feed and provide audio playback, but not allowing VCA1 to get the audio capture feed or provide audio playback (the call in VCA1 is muted). At this point, VCA2 has the communication focus. The audio manager sends notifications to VCA1, which is registered for notifications, and VCA1 (at its discretion) puts its call on hold.

When the call in VCA2 ends, the Web browser and VCA1 are still in the background, and the call in VCA1 is still on hold. VCA1 is switched back to the main part of the UI, either automatically when VCA2 ends its call or in response to user input. VCA2 is switched to the background. In response to the changes in UI focus/visibility, the audio manager allows VCA1 (but not VCA2) to get the audio capture feed and provide audio playback, and VCA1 is unmuted. The call in VCA1 continues.

The user then switches the Web browser to the main part of the UI, and VCA1 is switched to the background. At this point, all audio capture applications that are running are in the background. VCA1 retains the communication focus as the most recently used audio capture application. The call in VCA1 can continue while the user browses the Web.

TABLE 1
Scenario 1

| | Main | Docking | Back- | Comm. | |
|---|---|---|---|---|---|
| Action | Part | Bar | ground | Focus | Notes |
| | VCA1 | none | browser, | VCA1 | |
| | | | VCA2 | | |
| answer call | VCA2 | none | browser, | VCA2 | VCA1 on hold |
| in VCA2 | | | VCA1 | | (up to VCA1) |
| end VCA2 | VCA2 | none | browser, | VCA2 | VCA1 on hold |
| call | | | VCA1 | | (up to VCA1) |
| return to | VCA1 | none | browser, | VCA1 | |
| VCA1 | | | VCA2 | | |
| browse the | browser | none | VCA1, | VCA1 | |
| Web | | | VCA2 | | |

Table 2 shows audio management for a second example scenario. The first two rows of Table 2 are the same as in Table 1, and audio management happens as in the first example scenario for these actions. During the call in VCA2, however, the user looks up a contact in an address book application. At this point, the address book application is switched to the main part of the UI, and VCA2 is switched to the background (with the Web browser and VCA1). The audio manager reacts to these changes by applying its rules. Since all audio capture applications that are running are in the background, VCA2 retains the communication focus as the most recently used audio capture application. Later, the address book application is closed. The call in VCA2 ends, and the call in VCA1 continues, as explained with reference to the first example scenario.

TABLE 2
Scenario 2

| | Main | Docking | Back- | Comm. | |
|---|---|---|---|---|---|
| Action | Part | Bar | ground | Focus | Notes |
| | VCA1 | none | browser, | VCA1 | |
| | | | VCA2 | | |
| answer call | VCA2 | none | browser, | VCA2 | VCA1 on hold |
| in VCA2 | | | VCA1 | | (up to VCA1) |
| look up | address | none | browser, | VCA2 | VCA1 on hold |
| contact | book | | VCA1, | | (up to VCA1) |
| | | | VCA2 | | |
| end VCA2 | VCA2 | none | browser, | VCA2 | VCA1 on hold |
| call | | | VCA1 | | (up to VCA1) |
| return to | VCA1 | none | browser, | VCA1 | |
| VCA1 | | | VCA2 | | |

Table 3 shows audio management for a third example scenario. The first two rows of Table 3 are the same as Tables 1 and 2, and audio management happens as in the first and second example scenarios for these actions. During the call in VCA2, the user looks up a contact in an address book application, as in the second example scenario. After the address book application is closed, however, the user accidentally returns VCA1 to the main part of the UI. The user returns to the call in VCA1, and VCA1 temporarily has the communication focus as a foreground application, so that the call in VCA1 is unmuted and VCA1 (as a registered application) processes notifications from the audio manager accordingly. The audio manager also sends notifications to VCA2 (also registered for notifications), whose call is muted since VCA2 is in the background. VCA2 may (at its discretion) put its call on hold.

Eventually, VCA2 is switched back to the main part of the UI, and VCA1 is switched to the background. In response to these changes in UI focus/visibility, the audio manager allows VCA2 (but not VCA1) to get the audio capture feed and provide audio playback. The call in VCA1 is muted, and the call in VCA2 is unmuted. The audio manager sends notifications to VCA1 and VCA2. The call in VCA1 is put on hold, at the discretion of VCA1. The last three rows of Table 3 are the same as in Table 1, and audio management happens as in the first example scenario for these actions.

TABLE 3
Scenario 3

| | Main | Docking | Back- | Comm. | |
|---|---|---|---|---|---|
| Action | Part | Bar | ground | Focus | Notes |
| | VCA1 | none | browser, | VCA1 | |
| | | | VCA2 | | |
| answer call | VCA2 | none | browser, | VCA2 | VCA1 on hold |
| in VCA2 | | | VCA1 | | (up to VCA1) |
| look up | address | none | browser, | VCA2 | VCA1 on hold |
| contact | book | | VCA1, | | (up to VCA1) |
| | | | VCA2 | | |
| accidentally | VCA1 | none | browser, | VCA1 | VCA2 on hold |
| return to | | | VCA2 | | (up to VCA2) |
| VCA1 | | | | | |
| return to | VCA2 | none | browser, | VCA2 | VCA1 on hold |
| call in | | | VCA1 | | (up to VCA1) |
| VCA2 | | | | | |
| end VCA2 | VCA2 | none | browser, | VCA2 | VCA1 on hold |
| call | | | VCA1 | | (up to VCA1) |
| return to | VCA1 | none | browser, | VCA1 | |
| VCA1 | | | VCA2 | | |
| browse the | browser | none | VCA1, | VCA1 | |
| Web | | | VCA2 | | |

Table 4 shows audio management for a fourth example scenario. In this scenario, there are multiple voice communication applications in the foreground. VCA1 is in the main part of the UI, and VCA2 is in the docking bar. In this scenario, each of VCA1 and VCA2 has the communication focus.

TABLE 4
Scenario 4

| | Main | Docking | Back- | Comm. | |
|---|---|---|---|---|---|
| Action | Part | Bar | ground | Focus | Notes |
| | VCA1 | VCA2 | browser | VCA1, | both have |
| | | | | VCA2 | focus when in |
| | | | | | foreground |

The audio manager and rules for audio management can be used in other scenarios.

### Generalized Techniques for Managing Audio Capture

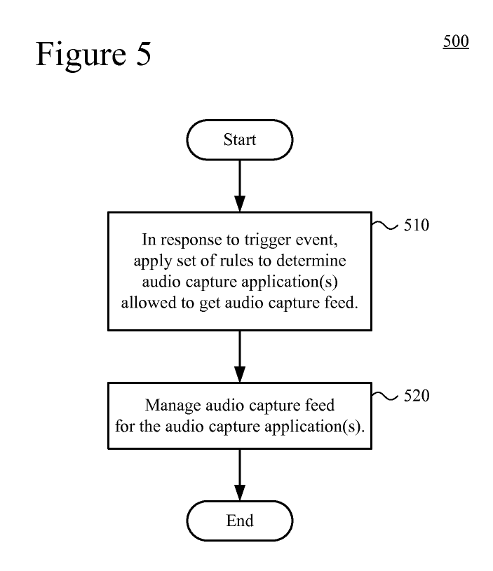

FIG. 5 shows a generalized technique (500) for managing audio capture for one or more audio capture applications. A computer system that implements an audio manager can perform the technique (500). For example, the audio manager can be implemented as part of an operating system of the computer system, which can be a desktop computer, laptop computer, tablet or slate computer, smartphone, gaming console, or other type of computer system. With the technique (500), the audio manager can manage an audio capture feed even when multiple audio capture applications are permitted to be in calls concurrently. An audio capture application can be a standalone voice telephony application (VoIP or otherwise), a voice telephony tool in a communication suite, a voice chat feature integrated into a social network site or multi-player game, a simple audio recording application, a speech-to-text application, or any other audio processing software that uses an audio capture feed.

In response to a trigger event, the audio manager applies (510) a set of rules to determine which of one or more audio capture applications is allowed to get an audio capture feed. For example, the set of rules is based at least in part on (a) which of the audio capture application(s) is in the foreground of a UI of the computer system, (b) which of the audio capture application(s) is in background of the UI, and (c) which of the audio capture application(s) was most recently used. Alternatively, the audio manager considers other and/or additional rules.

The set of rules can be implemented as decision logic according to which the audio manager, for a given one of the audio capture application(s), determines if the given application is visible in the UI. If the given audio capture application is visible in the UI, the audio manager allows the given application to get the audio capture feed. If no audio capture application is visible in the UI, the audio manager can determine a most recently used audio capture application and allow the most recently used audio capture application to get the audio capture feed. In this way, in response to the trigger event, the audio manager can evaluate every audio capture application running concurrently in the computer system according to the decision logic.

The trigger event can be a stream event that indicates one of the audio capture application(s) has started or stopped a communication stream (or other audio stream that can use the audio capture feed). Or, the trigger event can indicate one of the audio capture application(s) has changed focus in a UI or changed visibility in the UI. Or, the trigger event can be a user change event. Alternatively, the audio manager reacts to other and/or additional types of trigger events.

Returning to FIG. 5, the audio manager manages (520) the audio capture feed for the audio capture application(s). The audio manager can also send a notification to each of the voice communication application(s) that is registered for notifications, so as to indicate whether the application is allowed to get the audio capture feed. The audio manager can also manage audio playback for each of the audio capture application(s) that provides audio output, and the audio manager can send a notification to each of the audio capture application(s) that is registered for notifications, so as to indicate sound level for the application. To receive such notifications from the audio manager, the voice communication application(s) can register through a registration interface.

### Alternatives and Variations

Various alternatives to the foregoing examples are possible.

In some of the foregoing examples, an audio manager sends notifications about audio capture state, audio playback state, etc. only to those applications that have registered to receive such notifications (e.g., registered through a registration interface of an operating system). Alternatively, an audio manager sends such notifications to all applications or to all applications in a category of interest for such notifications (e.g., all voice communication applications, all audio capture applications, all audio applications).

Although the operations of some of the disclosed techniques are described in a particular, sequential order for convenient presentation, it should be understood that this manner of description encompasses rearrangement, unless a particular ordering is required. For example, operations described sequentially may in some cases be rearranged or performed concurrently. Also, operations can be split into multiple stages and, in some cases, omitted.

The various aspects of the disclosed technology can be used in combination or separately. Different embodiments use one or more of the described innovations. Some of the innovations described herein address one or more of the problems noted in the background. Typically, a given technique/tool does not solve all such problems.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

The disclosed methods, apparatus, and systems should not be construed as limiting in any way. Instead, the present disclosure is directed toward all novel and non-obvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method of managing audio capture in a computer system that permits multiple audio capture applications to get an audio capture feed concurrently, the method comprising, with an audio manager of the computer system:
in response to a trigger event, applying a set of rules to determine which of one or more audio capture applications is allowed to get an audio capture feed; and
managing the audio capture feed for the one or more audio capture applications.

2. The method of claim 1 further comprising, with the audio manager of the computer system, managing audio playback for the one or more audio capture applications, wherein at least one of the one or more audio capture applications also provides audio output.

3. The method of claim 1 wherein the audio manager is implemented as part of an operating system of the computer system.

4. The method of claim 1 wherein the set of rules is based at least in part on: (a) which of the one or more audio capture applications is in foreground of a user interface of the computer system, (b) which of the one or more audio capture applications is in background of the user interface of the computer system, and (c) which of the one or more audio capture applications was most recently visible.

5. The method of claim 4 wherein the foreground includes a main part and a docking bar.

6. The method of claim 1 wherein the trigger event indicates start or stop of a stream that can use the audio capture feed.

7. The method of claim 1 wherein the trigger event indicates an application has changed focus in a user interface or visibility in the user interface.

8. The method of claim 1 wherein the trigger event indicates a user change.

9. The method of claim 1 wherein the set of rules is implemented as decision logic that includes, for a given audio capture application of the one or more audio capture applications:
determining if the given audio capture application is visible in a user interface;
if the given audio capture application is visible in the user interface, allowing the given audio capture application to get the audio capture feed.

10. The method of claim 9 wherein the decision logic further includes:
if no audio capture application is visible in the user interface, determining a most recently visible audio capture application of the one or more audio capture applications and allowing the most recently visible audio capture application to retain the audio capture feed.

11. The method of claim 9 wherein every audio capture application that is capable of getting the audio capture feed and running concurrently in the computer system is evaluated according to the decision logic in response to the trigger event.

12. The method of claim 1 further comprising:
sending a notification to each of the one or more audio capture applications to indicate whether the audio capture application is allowed to get the audio capture feed.

13. The method of claim 1 wherein each of the one or more audio capture applications is a voice communication application.

14. A computer system comprising a processor, memory and storage storing software for an audio management architecture, the architecture comprising:
an event monitor adapted to monitor for types of trigger events;
a registration interface adapted to register audio capture applications; and
an audio manager adapted to, in response to one of the trigger events:
apply a set of rules to determine which of the audio capture applications is allowed to get an audio capture feed; and
manage the audio capture feed for the audio capture applications.

15. The computer system of claim 14 wherein the event monitor is adapted to monitor whether an audio capture stream starts or stops.

16. The computer system of claim 14 wherein the event monitor is adapted to monitor changes in user interface focus or user interface visibility.

17. The computer system of claim 14 wherein the event monitor is adapted to monitor user changes.

18. The computer system of claim 14 wherein the audio manager is further adapted to manage audio playback for those of the audio capture applications that also provide audio output.

19. A computer-readable medium storing computer-executable instructions for causing a processor programmed thereby to perform a method of managing audio capture and audio playback for voice communication applications, the method comprising:
in response to a trigger event, applying a set of rules to determine which of one or more voice communication applications is allowed to get an audio capture feed, wherein the set of rules is based at least in part on:
(a) which of the one or more voice communication applications is in foreground of a user interface of the computer system,
(b) which of the one or more voice communication applications is in background of the user interface of the computer system, and
(c) which of the one or more voice communication applications was most recently visible;
managing the audio capture feed for the one or more voice communication applications;
sending a notification to each of the one or more voice communication applications that is registered for notifications so as to indicate whether the voice communication application is allowed to the get audio capture feed; and
managing audio playback for the one or more voice communication applications.

20. The computer-readable medium of claim 19 wherein the method further comprises monitoring for types of trigger event, wherein the types of trigger event include a communication stream event, a change in user interface focus or visibility, and a user change event.
